(19) United States
(12) Patent Application Publication
(10) Pub. No.: US 2009/0166400 A1
(43) Pub. Date: Jul. 2, 2009

(54) EXPANDABLE FILE FOLDER WITH A CLOSABLE POCKET

(75) Inventor: Victor LEE, Shenzhen (CN)

Correspondence Address: PATENTTM.US, P. O. BOX 82788, PORTLAND, OR, 97282-0788, US

(73) Assignee: LIFE GROUP STATIONERY CO., LTD., Shenzhen (CN)

(21) Appl. No.: 12/337,585

(22) Filed: Dec. 17, 2008

(30) Foreign Application Priority Data
Dec. 28, 2007 (CN) 200720196617.0.

(51) Int. Cl. B65D 27/00; B65D 37/00; B42D 1/00

(52) U.S. Cl. 229/67.3; 229/67.4; 229/67.1; 281/38

(57) ABSTRACT

An expandable file folder with a closable pocket has a body, two accordion sides, multiple partitions and at least one closable pocket. A chamber is formed in the body between the accordion sides. The closable pocket is mounted in the chamber and each closable pocket has a front panel a rear panel and a fastener. The front panel is mounted on the rear panel by bonding along sides of the front and rear panels. The fastener is attached to the front and rear panels to selectively close the pocket and may be a resealable zipper, a leaf with a button, hook and loop fasteners or the like. Therefore, the closable pocket may be used conveniently to store non-paper items such as stationary, name cards or the like.

### BACKGROUND OF THE INVENTION

1. Field of the Invention

The present invention relates to an expandable file folder, and more particularly to an expandable file folder having a closable pocket.

2. Description of the Prior Arts

A file folder is used to store and transport documents As the file folder is portable, people who often visit customers frequently carry a file folder. A conventional file folder may be paper, cloth, leather or the like. However, the conventional file folder has a large fixed chamber, which causes the file folder to be large and inconvenient to carry so a plastic expandable file folder was created and has become popular.

The conventional plastic expandable file folder can store a lot of documents conveniently but cannot store non-paper items such as stationary, name cards or the like securely. Therefore, the non-paper items may either be stored lose or in an additional holder to prevent loss or damage to the non-paper items.

To overcome the shortcomings, the present invention provides an expandable file folder to mitigate or obviate the aforementioned problems

### SUMMARY OF THE INVENTION

The primary objective of the present invention is to provide an expandable file folder having a closable pocket.

An expandable file folder with a closable pocket has a body, two accordion sides, multiple partitions and at least one closable pocket. A chamber is formed in the body between the accordion sides. The closable pocket is mounted in the chamber and has a front panel a rear panel and a fastener. The front panel is mounted on the rear panel by bonding along sides of the front and rear panels. The fastener is attached to the front and rear panels to selectively close the pocket and may be a resealable zipper, a leaf with a button, hook and loop fasteners or the like. Therefore, the closable pocket may be used conveniently to store non-paper items such as stationary, name cards or the like.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of an expandable file folder with a closable pocket in accordance with the present invention;

FIG. 2 is a perspective view of a first embodiment of a closable pocket for an expandable file folder in accordance with the present invention;

FIG. 3 is a perspective view of a second embodiment of a closable pocket for an expandable file folder in accordance with the present invention;

FIG. 4 is a perspective view of a third embodiment of a closable pocket for an expandable file folder in accordance with the present invention; and

FIG. 5 is a perspective view of a forth embodiment of a closable pocket for an expandable file folder in accordance with the present invention.

### DETAILED DESCRIPTION OF THE PREFERRED EMBODIMENTS

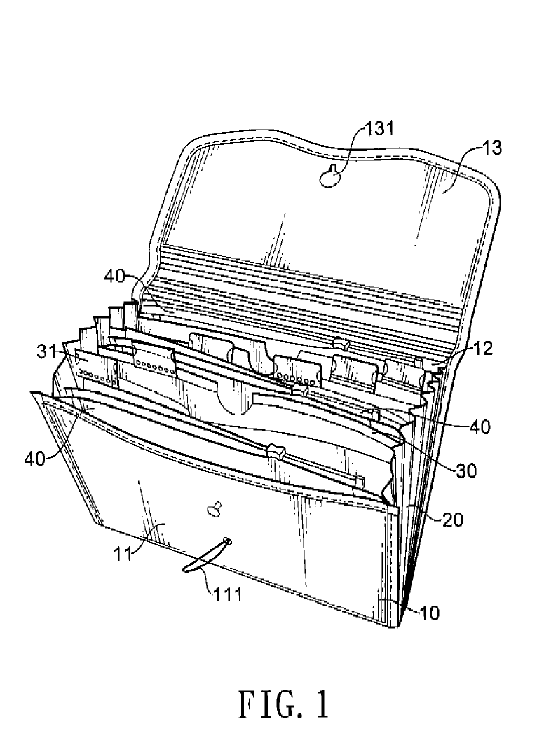

With reference to FIG. 1, an expandable file folder with a closable pocket in accordance with the present invention comprises a body (10), two accordion sides (20), multiple partitions (30) and at least one closable pocket (40).

The body (10) is plastic and has a front (11), a rear (12), a cover (13), a chamber and a closed bottom. The front (11) has an outer surface and two sides. The outer surface of the front (11) has a fastener (111) that may be a string, a hook, a button hole, magnet or the like. The rear (12) has an open edge and two sides. The cover (13) is formed on and protrudes from the open edge of the rear (12) of the body and has a fastener (131). The fastener (131) of the cover (13) corresponds to and connects to the fastener (111) of the front (11) of the body (10) and may be a hook, a string, a button, magnet or the like. The hook on the cover (13) is hooked by the string on the front (11). The button on the cover (13) connects to the button hole on the front (11). The closed bottom is formed between the front (11) and the rear (12) of the body (10). The chamber is defined between the front, the rear and the closed bottom of the body (10) and has an inner surface.

The accordion sides (20) are plastic and are formed between and connect the sides of the front (11) and the rear (12) of the body (10), are symmetrical and each accordion side (20) is expandable and has multiple bends forming peaks and troughs. The accordion sides (20) may be attached between the front (11) and the rear (12) of the body (10) by bonding, thermal welding, gluing or other ways known in the art for attaching plastics.

The partitions (30) are plastic and may be transparent plastic, plastic pervious to light, opaque plastic, or plastic impervious to light, are mounted in the chamber of the body (10) and each partition (30) has an open edge, two sides and an index tab (31). The sides of each partition (30) are respectively connected to the bends of corresponding accordion sides (20) and may be bonded to the accordion sides (20) by thermal welding or other ways known in the art to separate the chamber of the body (10) into multiple compartments. The index tabs (31) arc respectively formed on and protrude from the open edge of the partitions (30) and allows documents to be classified.

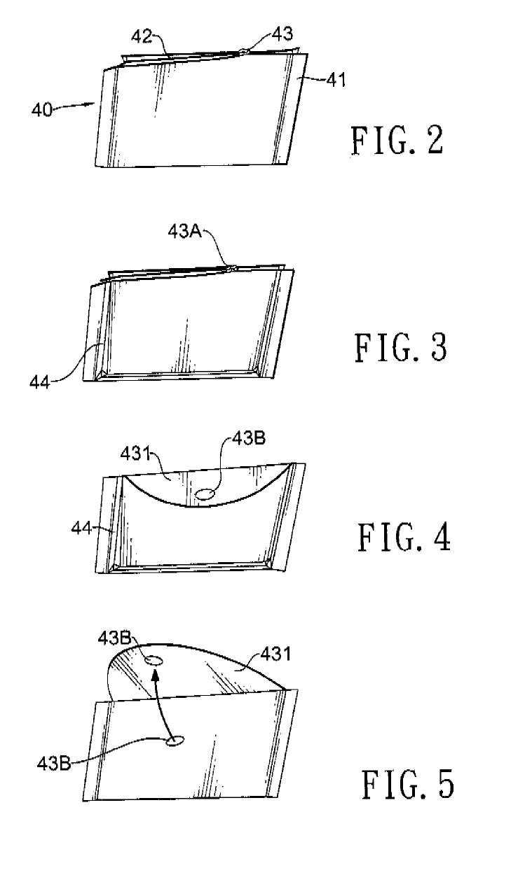

With further reference to FIG. 2, the at least one closable pocket (40) is plastic, is mounted in the chamber of the body (10), may be bonded to the inner surface of the chamber adjacent to the front (11) of the body (10) or the rear (12) of the body (10) or may be bonded to one partition (30). Each one of the at least one closable pocket (40) has a front panel, a rear panel, two connecting tabs (41), an opening (42) and a fastener (43).

The rear panel is mounted in the chamber of the body (10) and has an open edge and two sides.

The front panel is mounted on the rear panel and has two sides. The sides of the front panel are respectively connected to the sides of the rear panel.

The connecting tabs (41) are formed on and protrude respectively from the sides of the rear panel and may be bonded to the inner surface of the chamber, may be adjacent to the front (11) or the rear (12) of the body (10) or may be bonded to one partition (30) or may be respectively bonded to the corresponding accordion sides (20) and may be bonded by thermal welding, gluing or other ways known in the art to connect plastics.

The opening (42) of the closable pocket (40) is formed between the front and rear panels of the closable pocket (40).

With further reference to FIGS. 3 to 5, the fastener (43) of the closable pocket (40) is attached to the front and rear panels of the closable pocket (40), selectively closes the opening (42) by connecting the front and rear panels of the closable pocket (40), and may be a resealable zipper (43A), magnet, button and hook (433), hook and loop fastener or the like and may comprise a leaf (431). The leaf (431) of the fastener (43) of the closable pocket (40) is formed on and protrudes from the rear panel of the closable pocket (40) and may have a button, hook, magnet, hook and loop fastener or the like formed on the leaf (431) and corresponding to the fastener (43) on the front panel.

The closable pocket (40) may be implemented with two accordion sides (44).

Therefore, the expandable file folder with a closable pocket (40) in accordance with the present invention can be used conveniently to store non-paper items such as stationary, name cards or the like securely. Further, the non-paper items do not be stored lose or in an additional holder to prevent loss or damage to the non-paper items.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. An expandable file folder comprising:
a body having
a front having two sides;
a rear having two sides; and
a chamber being defined between the front and rear of the body and having an inner surface;
two accordion sides being formed between and connecting the sides of the front and the rear of the body;
multiple partitions being mounted in the chamber of the body and being mounted between the accordion sides; and
at least one closable pocket being mounted in the chamber of the body, and each one of the at least one closable pocket having
a rear panel being mounted in the chamber of the body having an open edge and two sides;
a front panel being mounted on the rear panel and having two sides being respectively connected to the sides of the rear panel;
two connecting tabs being formed on and protruding respectively from the sides of the rear panel;
an opening being formed between the front and rear panels of the closable pocket; and
a fastener being attached to the front and rear panels of the closable pocket to selectively close the opening by connecting the front and rear panels.

2. The expandable file folder as claimed in claim 1, wherein the at least one closable pocket is bonded to the inner surface of the chamber adjacent to the front of the body.

3. The expandable file folder as claimed in claim 1, wherein the at least one closable pocket is bonded to the inner surface of the chamber adjacent to the rear of the body.

4. The expandable file folder as claimed in claim 1, wherein the at least one closable pocket is bonded to one of the partitions.

5. The expandable file folder as claimed in claim 1, wherein the connecting tabs of the at least one closable pocket are respectively bonded to the accordion sides.

6. The expandable file folder as claimed in claim 2, wherein the connecting tabs of the at least one closable pocket are respectively bonded to the accordion sides.

7. The expandable file folder as claimed in claim 3, wherein the connecting tabs of the at least one closable pocket are respectively bonded to the accordion sides.

8. The expandable file folder as claimed in claim 4, wherein the connecting tabs of the at least one closable pocket are respectively bonded to the accordion sides.

9. The expandable file folder as claimed in claim 1, wherein each one of the at least one closable pocket is implemented with two accordion sides.

10. The expandable file folder as claimed in claim 2, wherein each one of the at least one closable pocket is implemented with two accordion sides.

11. The expandable file folder as claimed in claim 3, wherein each one of the at least one closable pocket is implemented with two accordion sides.

12. The expandable file folder as claimed in claim 4, wherein each one of the at least one closable pocket is implemented with two accordion sides.

13. The expandable file folder as claimed in claim 1, wherein the fastener of each one of the at least one closable pocket is a resealable zipper.

14. The expandable file folder as claimed in claim 2, wherein the fastener of each one of the at least one closable pocket is a resealable zipper.

15. The expandable file folder as claimed in claim 3, wherein the fastener of each one of the at least one closable pocket is a resealable zipper.

16. The expandable file folder as claimed in claim 4, wherein the fastener of each one of the at least one closable pocket is a resealable zipper.

17. The expandable file folder as claimed in claim 1, wherein the fastener of each one of the at least one closable pocket further comprises a leaf being formed on and protruding from the open edge of the rear panel of the closable pocket.

18. The expandable file folder as claimed in claim 2, wherein the fastener of each one of the at least one closable pocket further comprises a leaf being formed on and protruding from the open edge of the rear panel of the closable pocket.

19. The expandable file folder as claimed in claim 3, wherein the fastener of each one of the at least one closable pocket further comprises a leaf being formed on and protruding from the open edge of the rear panel of the closable pocket.

20. The expandable file folder as claimed in claim 4, wherein the fastener of each one of the at least one closable pocket further comprises a leaf being formed on and protruding from the open edge of the rear panel of the closable pocket.
